(19) United States
(12) Patent Application Publication
(10) Pub. No.: US 2004/0191537 A1
(43) Pub. Date: Sep. 30, 2004

(54) Restricted access material for spme

(76) Inventors: Dieter Lubda, Bensheim (DE); Christian Schafer, Darmstadt (DE); Janusz Pawliszyn, Waterloo (CA); Wayne M Mullett, Kittchener (CA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/480,238

(22) PCT Filed: May 16, 2002
(86) PCT No.: PCT/EP02/05396

(30) Foreign Application Priority Data
Jun. 13, 2001 (EP) 01114325.2

(51) Int. Cl. B32B 25/20

(52) U.S. Cl. 428/447

(57) ABSTRACT

This invention relates to a stationary phase for solid phase microextraction (SPME) comprising a surface built up by a RAM (restricted access material) phase, a device for SPME comprising said stationary phase and a method for SPME using said stationary phase. The RAM SPME stationary phases according to the invention are robust, providing many direct extractions and subsequent determinations, while overcoming the present disadvantages of direct sampling of biological matrices by SPME.

This invention relates to a stationary phase for solid phase microextraction (SPME) comprising a surface at least partially build up by a RAM (restricted access material) material, a device for SPME comprising said stationary phase and a method for SPME using said stationary phase.

Solid-phase microextraction (SPME) is a sampling and sample preparation technique invented for volatile organic compound analysis in environmental samples over ten years ago (R. G. Belardi, and J. Pawliszyn, J. Water Pollut. Res. Can. 1989, 224, 179). SPME provides many advantages over conventional sampling methods by integrating sample extraction, concentration, and introduction into a single step. SPME has been successfully coupled with gas chromatography (GC), high performance liquid chromatography (HPLC) and capillary electrophoresis and has found numerous applications in many disciplines (J. Pawliszyn (ed.) Applications of Solid Phase Microextraction. RSC, Cornwall, UK, 1999). As stationary phase for,SPME, generally, fibers like uncoated fused silica fibers or fused silica fibers coated with e.g. PDMS (polydimethylsiloxan) or polyimide films are used (EP 0 523 092).

Most recently, SPME has been extended to various aspects of biological sample analysis and has been the subject of several reviews (G. Theodoridis, E. H. M. Koster, and G. J de Jong, J. Chromtogr. B 2000, 745, 49; H. Lord, and J. Pawliszyn, J. Chromatogr. A 2000, 902, 17; N. H. Snow, J Chromtogr. A 2000, 885, 445). However, with respect to biological sample analysis using commercially available fibers, SPME has met some difficulties. The preferred extraction mode in the SPME analysis of biological samples is headspace extraction, it produces cleaner extracts and longer fiber lifetimes because of minimal fiber fouling resulting from protein adsorption during direct extraction (E. H. M Koster, C. Wemes, J. B. Morsink, and G. J. de Jong, J. Chromatogr. B 2000, 739, 175).

Unfortunately, most drug compounds or other compounds of interest are semi or non-volatile organic compounds making SPME headspace extraction of body fluids impossible to analyze.

Direct immersion of the SPME device into the sample solution often results in poor extraction of the compound of interest as their enrichment is inhibited by adsorption of e.g. macromolecules like proteins which are also present in the sample. In addition, one observes fiber fouling resulting from protein adsorption during direct extraction. Therefore the determination of specific compounds of interest often requires sample pretreatment involving tedious and complex pretreatment or extraction protocols.

So far, to be able to perform direct SPME of complex biological materials, the fiber of the SPME device is surrounded by a porous membrane to hinder compounds like proteins from reaching the fiber (Anal. Corn. 33, (1996) 129-131). It can be easily understood that the kinetics of this membrane extraction are substantially slower than for direct extraction, because the analytes have to pass the membrane before they can reach the fiber. In addition, the membrane coating is a feature that makes the device more complicated.

It would be favorable to have an extraction fiber and device for SPME of biological samples which allows a direct extraction mode without any pretreatment of the sample. Extraction should be possible without protecting the fiber with additional devices like a membrane.

It has been found that the use of a specific coating on the extraction fiber of the SPME device results in a great improvement of extraction efficiency. If the extraction fiber is coated with particles of a restricted access material, instead of coating it with the usual polymer films, the above mentioned disadvantages are overcome. Due to the special RAM coating, during extraction the sample is fractionated into the protein matrix and the analyte fraction. The low molecular weight compounds of interest are effectively extracted and enriched, via partition into the phase's interior. Utilizing the RAM particles, preferably alkyl-diol-silica (ADS) particles, as a SPME coating can further simplify the extraction process, while completely eliminating the requirement of extraction solvents. Clean-up of the sample and extraction of the analyte can be performed in one step.

The present invention therefore relates to a stationary phase for SPME comprising a surface built up by a restricted access material. The stationary phase may by a solid shaped article totally built up by RAM material or a shaped article whose surface is at least partially covered with such a material.

In a preferred embodiment the stationary phase is a hollow fiber whose internal surface is covered with a restricted access material.

In another preferred embodiment the stationary phase is a solid fiber which is covered with a restricted access material.

In a preferred embodiment the restricted access material comprises a non-swelling inorganic base material.

In a preferred embodiment the restricted access material is an ADS (alkyl-diol-silica) material.

In another preferred embodiment the restricted access material consists of particles of a diameter between 5 μm and 50 μm.

In a preferred embodiment the restricted access material is glued on a support.

The present invention further relates to a device for SPME comprising a stationary phase according to the present invention.

### The present invention further relates to a method for SPME comprising immersing a stationary phase according to the present invention in the sample.

In a preferred embodiment the sample is a biological fluid.

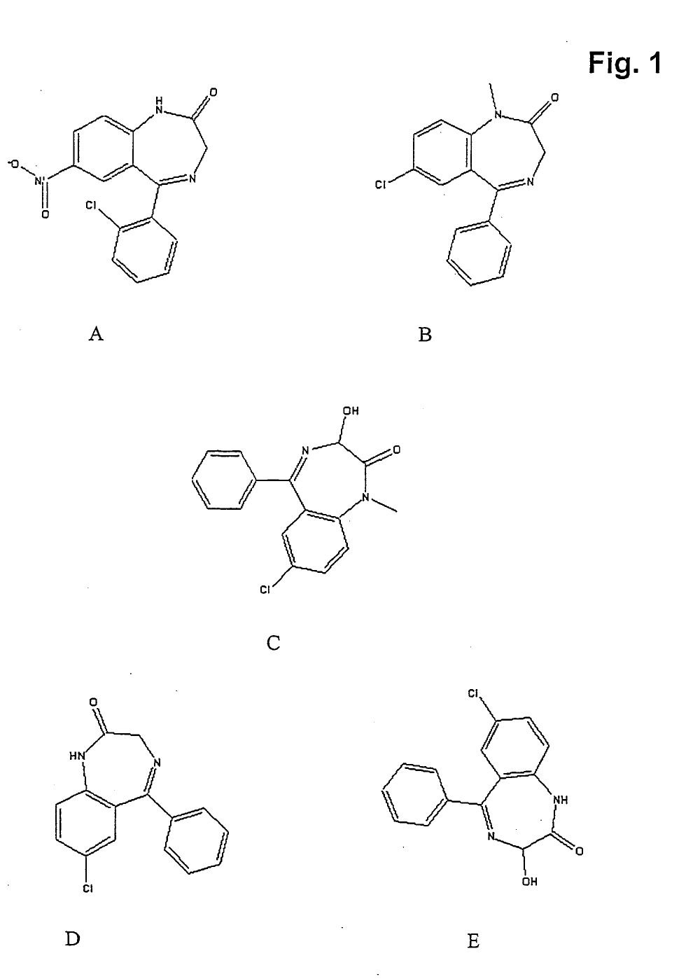

FIG. 1 shows the chemical structure of the 5 benzodiazepines used in example 2 (A=Clonazepam, B=Diazepam, C=Temazepam, D=Nordazepam, E=Oxazepam).

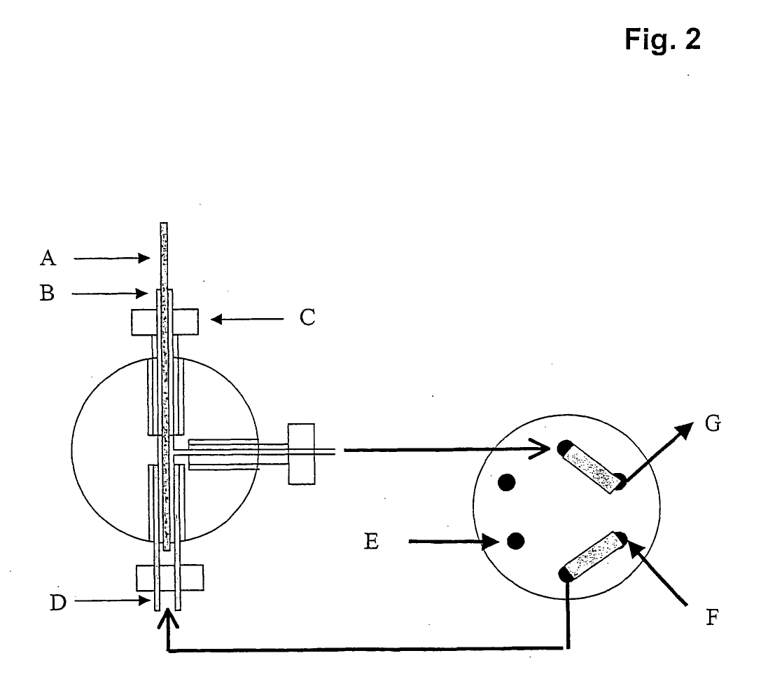

FIG. 2: Schematic representation of ADS-SPME HPLC interface in the inject position (desorption).

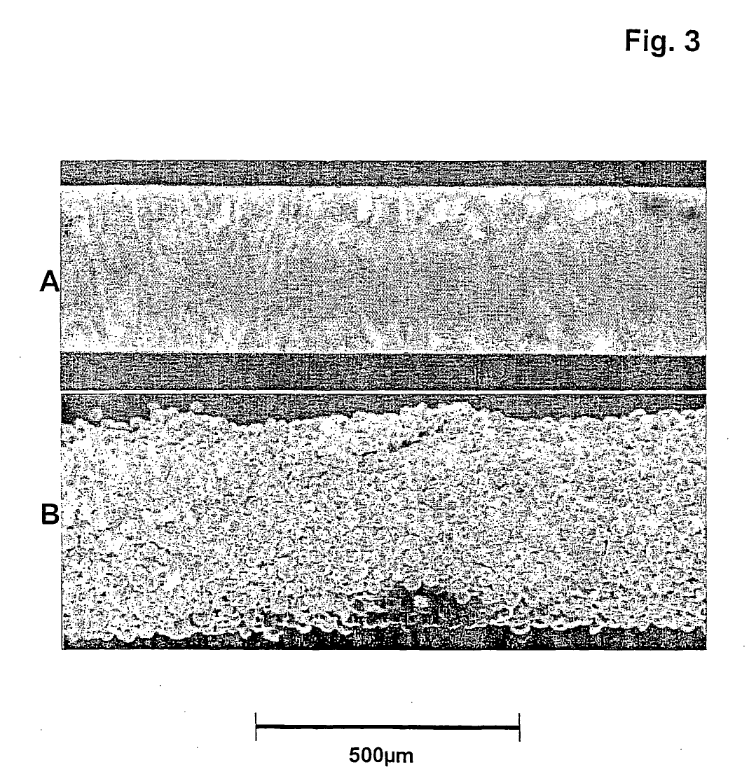

FIG. 3 shows scanning electron micrographs of bare silica fiber (A) and ADS-SPME fiber coating (B). Gold coating overlayer=30 nm; accelerator voltage=15 kV.

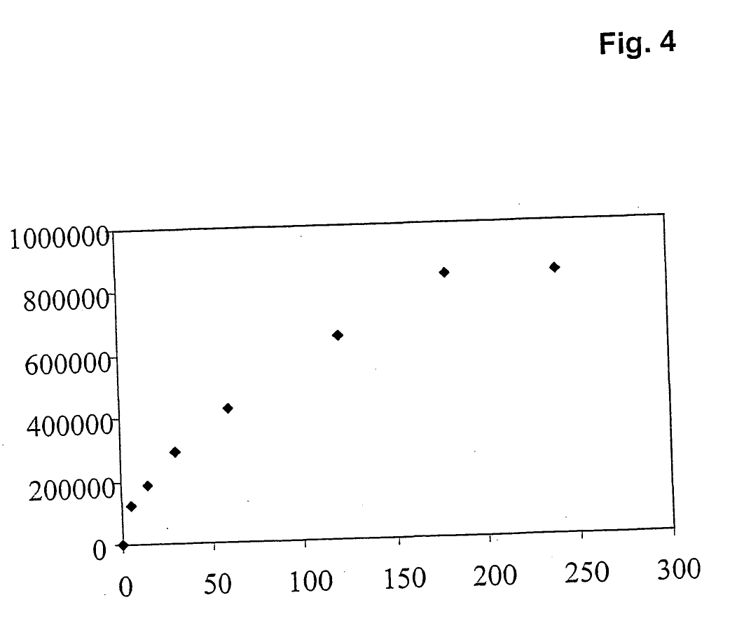

FIG. 4: ADS-SPME extraction time profile of 3.43 ng/mL ³H-diazepam.

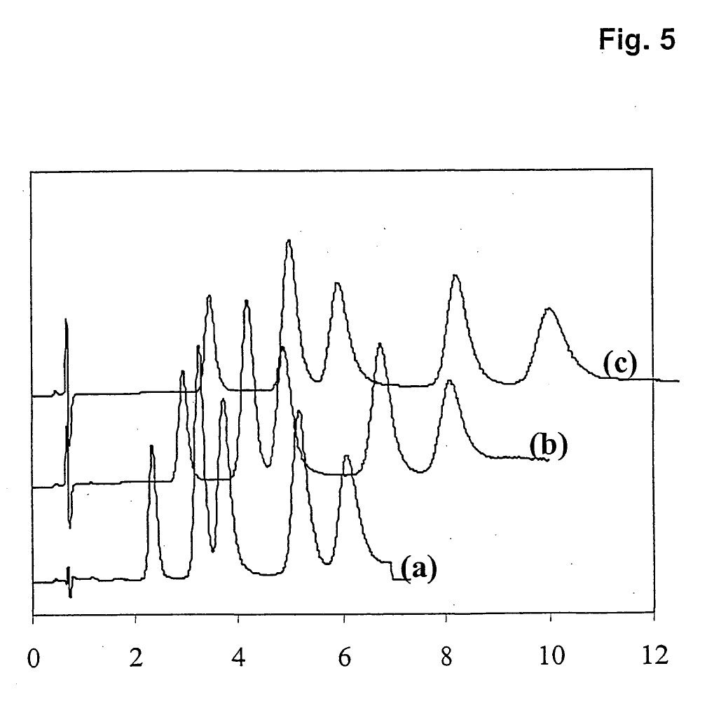

FIG. 5: Direct HPLC injection of 5 benzodiazepines using various ratios of water:methanol (v/v) for the mobile phase (a) 47:53 v/v (b) 50:50 (c) 52:48. Supelcosil C18 column (5.0 cm×4.6 mm i.d.; 5 μm particle size); sample concentration=10.0 μg/mL; injection volume=10 μL; flow rate of 1.0 mL/min; detection λ=230 nm.

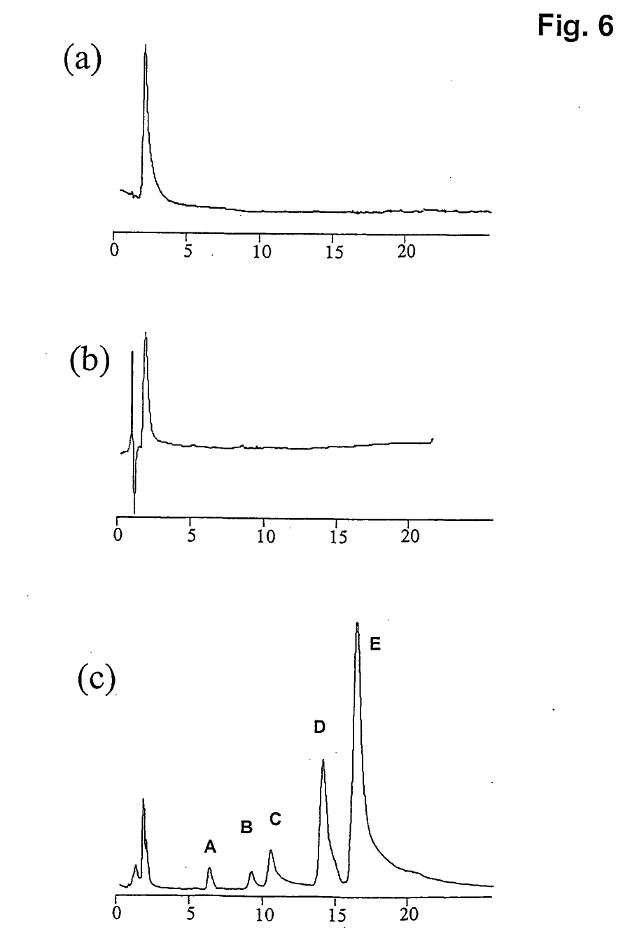

FIG. 6: (a) HPLC chromatogram for a bare silica control fiber after extraction with 1.0 μg/mL urine sample. (b) ADS-SPME HPLC chromatogram for blank urine. (c) ADS-SPME HPLC separation of 5 benzodiazepines in urine. Sample concentration=1,0 μg/mL; LiChrospher® RP-18 ADS, 25 μm; Supelcosil C18 column (5.0 cm×4.6 mm i.d.; 5 μm particle size); mobile phase=water-methanol (52:48 v/v); flow rate=0.75 mL/min; detection λ=230 nm.

### More details concerning the figures can be found in the Examples.

The RAM stationary phase according to the present invention can be used for SPME of any liquid sample (e.g. solution, suspension or emulsion). Preferably, it is used for the extraction of food (e.g. diary products) or biological fluids.

A biological fluid is a liquid sample like blood, serum, urine, a cell suspension, plant material, a cell extract, fermentation broth or any other sample containing large amounts of biological macromolecules like proteins or nucleic acids.

The RAM stationary phase according to the present invention is especially suitable for the extraction of biologically active substances like drugs or drug metabolites, hormones, vitamins, pesticides, toxins, food ingredients or cosmetics.

Restricted access materials are known for chromatographic use. RAM phases comprise porous base materials whose porous surfaces are occupied with functional ligands for the retention of target molecules (i.e. low molecular weight analytes, typically < about 5000 Da) and whose outer surface is biocompatible that means it excludes undesirable adsorption and/or denaturation or activation of or by components of biological fluids. Support materials of this type have diffusion barriers which make only a restricted distribution phase or surface accessible to macromolecular compounds. Examples for RAM materials are Internal Surface Reversed Phases (ISRP) (U.S. 4,544,485, EP 0 173 233), Shielded Hydrophobic Phases (SHP) (D. J. Gisch et al., J. Chromatogr. (1988) 433, 264), Semi Permeable Surfaces (SPS) (L. J. Glunz et al. Paper No. 490, Pittsburgh Conference, 1990) or Restricted Access Stationary Phases (RASP) (J. Haginaka (1991) Trends in Analytical Chemistry 1, 17). Further information about RAM phases can e.g. be found in C. Mislanova, A. Stefancova, J. Oravcova, J. Horecky, T. Trnovec, and W. Lindner, J. Chromatogr. B 2000, 739, 151; G. Lamprecht, T. Kraushofer, K. Stoschitzky and W. Lindner, J. Chromatogr. B 2000, 740, 219; R. Lauber, M. Mosimann, M. Buhrer, and A. M. Zbinden, J. Chromatogr. B 1994, 614, 69; J. D. Brewster et al., J. Chromatogr. (1992), 598, 23-31; EP 0 665 867 or EP 0 228 090. Often, the outer surface of RAM phases is hydrophilic while the pore surface is hydrophobic.

The base materials of the RAM phases can be porous organic or inorganic polymers. Suitable organic polymers are e.g. TSK-Gel® (Toyo Soda, Japan), Eupergite (Rohm, Germany). Suitable inorganic polymers are e.g. Nucleosil® (Macherey & Nagel, Germany), Controlled-pore-glass® (Electro-Nucleonics Inc. USA), Biorano glass (Schott, Germany) or, preferably, LiChrospher® (Merck KGaA, Germany). For use of the RAM phases according to the present invention, the base material preferably is an inorganic polymer like silica, as inorganic materials do not swell in organic solvents. In the past, the swelling of the SPME fibers during extraction, e.g. for HPLC measurement, was a major drawback as it makes it more difficult to handle the SPME device and may cause destruction of the fiber. These difficulties are overcome by using the RAM materials with an inorganic base material.

The functional groups that are bound to the pore surface or the outer surface of the base materials are well known to a person skilled in the art. For example, the pore surface might be covered with reversed phase ligands, affinity ligands (e.g. thiophilic or metal chelate ligands), chiral ligands or ionic ligands. Preferred reversed phase ligands are C4 to C18 ligands. The pore surface may also be covered with molecular imprinting materials.

The outer surface of the RAM base materials is typically covered with alkyl diols or other biocompatible polymers such as agarose or dextran.

In a preferred embodiment the RAM phases that are used according to the present invention are ADS (alkyl-diol-silica) materials or materials according to EP 0 537 461 or WO 99/16545. The materials according to EP 0 537 461 are porous particles comprising an outer surface and an inner reversed phase surface with fatty acid residues attached to aliphatic hydroxyl groups via ester bonds. WO 99/16545 discloses specific porous materials with hydrophilic outer surfaces and pore surfaces that are occupied by functional ligands. Those materials are produced by introduction of epoxide groups into a porous base material, catalytic ring opening of the epoxide groups by reaction with a nucleophile using a particulate catalyst, the particle size of the catalyst being greater than the average pore diameter of the porous base support and reaction of the epoxide groups of the pore surfaces and introduction of functional ligands. Further information about ADS materials can be found in A. El Mahjoub, and C. Staub, J. Chromatogr. B 2000, 742, 381; Z. X. Yu, D. Westerlund, and K. S. Boos, J. Chromatogr. B 2000, 740, 53 or K. S. Boos, and C. H Grimm, Trends Anal. Chem. 1999,18,175.

To improve the efficiency and specificity of the extraction, the functional ligands bound to the pore surface can be chosen depending on the type of analyte to be extracted. Further enhancements in the sensitivity of the RAM-SPME approach are sometimes possible through optimization of the sample matrix, such as e.g. sample salt concentration and pH.

Another possibility to design RAM-stationary phases with higher selectivity is to choose materials with a defined pore size. If for example RAM phases with mesopores within the range of 6 nm are used, analytes of up to about 20 kD are able to access inside the pores. To separate analytes with higher molecular weight it is also possible to use materials with mesopores of >6 nm. To separate analytes with smaller molecular weight, of course, materials with a smaller pore size can be used.

The RAM-phases to be used for SPME according to the present invention can be particulate materials or layers or shaped articles of solid materials. In case of solid materials, the whole stationary phase according to the present invention is built up by the RAM material (e.g. if a monolithic silica rod as disclosed in WO 94/19 687 or WO 95/03156 is used). In a preferred embodiment, the stationary phases according to the present invention comprise a support that is at least partially coated with a RAM phase (particles or a solid film).

Suitable supports to be coated with RAM phases are fibers or hollow fibers or other supports that are e.g. disclosed in H. Lord and J. Pawliszyn, J. Chrom. A, 885 (2000), 153-193.

The support that-can be coated with restricted access material according to the present invention should be chemically and physically stable to be

coated with the RAM phase

immersed into the liquid sample

extracted for further analysis via HPLC, GC, CEC, mass spectrometry or capillary electrophoresis.

Examples for suitable supports are organic or preferably inorganic polymer rods or organic or preferably inorganic solid or hollow fibers, e.g. fused silica solid or hollow fibers or very preferably metal needles (like needles used for a syringe) or metal rods. The dimensions of the supports are similar to those of supports that are usually used for SPME. For example, a fiber typically has a length of about 1 cm and a thickness of about 100 μm.

One example of a preferred film to be coated on a support is a porous silica layer that is produced by

providing a suitable cleaned support

applying a liquid film containing a polysilicic acid ester onto the support

introducing the support with the liquid film into an atmosphere which triggers the hydrolysis and further polymerization of the polysilicic acid ester

hydrolysis and further poylmerisation of the polysilicic acid ester at a constant temperature

washing and drying the silicic acid layer

Further details are disclosed in WO 99/41602. The film is then derivatized according to known methods to generate a RAM phase.

If the stationary phase comprises the RAM phase in form of a particulate coating, the RAM particles are preferably attached to the support by sintering or by coating of a sol (dipcoating) that leads to a gel at the support surface after drying. Another way is to use a mixture of particles with an inorganic binder or preferably by gluing.

The particles used for the coating normally have a diameter between below 100 μm, preferably below 50 μm, very preferably between 5 and 50 μm.

It might be necessary to pretreat the support by washing it with hydrogen peroxide and/or strong acids or strong bases to remove any coating which might hinder the attachment of the RAM coating. Afterwards, for gluing the RAM on the support, the support is covered with a thin and uniform layer of the adhesive glue and then contacted with the RAM particles e.g. by dipping it into a container with the particles.

The adhesive glue should be chemically stable against water and organic solvents to ensure that the RAM particles remain fixed to the support during traction. In addition, it should not swell in organic solvents. It is preferably an adhesive that can be cured by the application of light.

The chemical modification of the pore surface and the outer surface of the particles to build up a support with RAM properties on it's surface can be performed with the particles before coating or with the coated support afterwards.

The RAM coated stationary phase according to the present invention can be integrated in any device for carrying out microextraction. Such a device typically comprises a housing at least partially surrounding said stationary phase. The housing is e.g. a syringe with a plunger that is slidable within the barrel of the syringe to move the stationary phase, e.g. a fiber, in and out of the syringe. In another embodiment of a suitable device, the housing is formed by a syringe with a needle, whereby the inner surface of the needle is covered with the RAM coating. In another embodiment, the needle of the syringe is filled with the RAM material. The extraction is then carried out by filling the syringe with the sample solution, letting it run out of the syringe again and preferably repeating this at least two times to give the sample solution enough time to interact with the RAM phase within the needle. Examples for suitable housing devices are given in EP 0 523 092, DE 197 51 968, DE 196 19 790 or DE 195 25 771.

The SPME device comprising a stationary phase according to the present invention can be used for every sort of SPME, i.e. for example headspace configuration, membrane protection approach or direct extraction. (H. Lord and J. Pawliszyn, J. Chromatogr. (2000) 885, 153-193), very preferably for direct extraction.

For direct extraction, the stationary phase is immersed in the sample for a sufficient time to allow extraction to occur (The immersion time can range from less than one minute up to hours since it depends on experimental conditions such as agitation rate, temperature, calibration procedure, coating thickness, desired sensitivity, on the type of RAM phase etc.). To improve the interaction between the stationary phase and the sample solution, the sample might be stirred during extraction. The stationary phase is then removed from the sample solution and placed in a suitable analytical instrument in such a manner that desorption occurs with respect to the analytes. Analysis might be performed e.g. by gas chromatography, capillary electrophoresis, capillary electrochromatography, mass spectrometry or HPLC. The stationary phase, for example a fiber, is typically inserted into the instrument via an injection port. Suitable injection ports are known to persons skilled in the art. A preferred HPLC interface is shown in FIG. 2.

The RAM SPME stationary phases according to the invention are robust, providing many direct extractions and subsequent determinations, while overcoming the present disadvantages of direct sampling of biological matrices by SPME. Immobilization of the RAM particles onto a silica fiber provides a SPME fiber coating whereby the inert outer layer protects the coating from contamination by proteins, allowing direct and multiple extractions of biological fluids.

There is no requirement to precipitate proteins from the sample prior to extraction, therefore minimizing sample preparation time and eliminating potential sample preparation artifacts. All extracted analytes are injected in to the analytical system for detection. The binding capacity, the extraction efficiency and reproducibility of the stationary phases according to the present invention are very high. Due to their biocompatibility, many RAM-stationary phases can also be used for in-vivo extraction of analytes like drug compounds.

The present invention provides a new generation of SPME stationary phases for direct extraction of e.g. biological fluids because the clean-up of the sample and the extraction of the analyte is achieved in one step without the need for further separation tools like a membrane surrounding the stationary phase.

Without further elaboration, it is believed that one skilled in the art can, using the preceding description, utilize the present invention to its fullest extent. The preferred specific embodiments and examples are, therefore, to be construed as merely illustrative, and not limitative to the remainder of the disclosure in any way whatsoever.

The entire disclosures of all applications, patents, and publications cited above and below and of corresponding application EP 01 114325.2, filed Jun. 13, 2001, are hereby incorporated by reference.

### EXAMPLES

### Materials

All solvents were HPLC grade or better and purchased from Caledon (Georgetown, ON). The benzodiazepines, shown in FIG. 1, were purchased from Radian International (Tex., Austin, USA) as 1 mg/mL methanol solutions and stored at 4° C. ³H-diazepam was purchased from NEN™ Life Science Products, Inc. (Boston, Mass.) as 3.454 ug/mL ethanol solution. The specific activity was 82.5 Ci/mmol. Deionized water, from a Barnstead/Thermodyne NANO-pure ultrapure water system (Dubuque, Iowa, USA), was used for dilution of the standards. Fused silica optical fibers (various diameters) were purchased from Polymicro Technologies Inc (Pheonix, Ariz.). LiChrospher® RP-18 ADS, 25 μm ADS (alkyl-diol-silica) particles was supplied by Merck KGaA (Darmstadt, Germany).

### Example 1

### Preparation of ADS-SPME Fibers

The silica fibers were cut into 38 mm lengths and cleaned with a 30:70 mixture of 30% hydrogen peroxide (H₂O₂) and concentrated sulfuric acid (H₂SO₄) by ultrasonic wave for 1 h. They were thoroughly rinsed by sonification in water, pure ethanol and water respectively. This cleaning procedure was sufficient to remove the coating and buffer from the optical fibers. The ADS particles were immobilized on the silica fiber with Locktite® 349 adhesive (Rocky Hill, Conn.). After applying a thin and uniform layer of the adhesive glue, the silica fiber was carefully dipped into a 1.0 mL plastic Eppendorf micro-centrifuge tube containing the 25-μm ADS particles. The excess particles were removed from the fiber by gentle tapping. The adhesive was cured using a Locktite® Zeta 7500 portable UV lamp for 30 minutes. A Hitachi model S-570 (San Jose, Calif.) scanning electron microscope was used to image the prepared surface of the base-silica and the ADS-SPME fibers.

### Conditioning of ADS-SPME Fibers and Extraction of ³H-diazepam

The prepared fibers were initially conditioned in by successively shaking the submerged fibers in 2-propranol, methanol and water for 20 minutes. The fibers then stored in a water:methanol (95:5 v/v) mixture until ready to use. The ADS-SPME and blank silica fibers were placed in 1.5 mL Eppendorf (Brinkmann Instruments, Mississauga, ON) plastic micro-centrifuge tubes containing 1.0-mL of ³H-diazepam standard solution (prepared in water) over a range of concentrations and salt conditions followed by agitation on a shaker table for a specified time period. The fiber was removed and rinsed twice by total immersion in water and placed in scintillation vials containing 20 mL Ecolume scintillation cocktail. The vials were vigorously shaken and counted in a Beckman-Coulter (Fullerton, Calif.) model LS1701 scintillation counter, for 5 min. This completely removed the labeled diazepam from the fiber coating as determined by subsequent recounting of the fiber in fresh scintillation cocktail. A ³H-diazepam standard mass calibration curve was constructed for conversion of the DPM values to an absolute mass of diazepam.

### Example 2

### SPME of a Urine Sample Using ADS-Coated Fibers

### Instrumentation and Analytical Conditions

A Hewlett-Packard (Palo Alto, Calif.) HPLC system (model 1050) complete with autosampler and multiple wavelength UV detector (λ=230 nm) was used with a Supelcosil C18 column (5.0 cm×4.6 mm i.d.; 5 μm particle size) from Supelco (Bellefonte, Pa.). A LiChrosorb® RP-18 guard column (1 cm×4.6 mm) from Supelco (Bellefonte, Pa.) was installed at the inlet of the chromatographic column for protection of the analytical column. A SPME-HPLC interface was constructed as previously described (J. Chen, and J. B. Pawliszyn, Anal. Chem. 1995, 65, 2530) using a Valco zero volume tee from Chromatographic Specialties (Brockville, ON). However, the thru-hole of the tee was enlarged to facilitate a large diameter fiber. The ADS-SPME fiber was connected to the HPLC interface as shown in FIG. 2. Letter A to E in FIG. 2 show the following elements of the interface:

A=ADS-SPME fiber, B=1/16″ PEEK tubing (i.d.=0.02″), C=One piece finger tight PEEK fitting, D=1/16″ PEEK tubing (i.d.=0.03″), E=Inlet for additional solvent, F=Inlet from pump, G=Outlet to column. A to D belong to the desorption chamber shown on the left side of the figure, E to G belong to the 6 port injection valve shown on the right side. The 1/16″ PEEK tubings and nuts were received from Upchurch Scientific (Oak Harbor, Wash.). Elution of the extracted compounds from the ADS-SPME fiber and separation by the reverse phase HPLC column was accomplished with switching the 6-port injection valve to redirect the water-methanol (52:48 v/v) mobile phase over the fiber surface at a flow rate of 1.0 mL/min.

### Preparation of Urine Samples

Urine samples were collected from a drug free healthy volunteer. Any precipitated material was removed by centrifuging the sample at 10,000 g for 10 minutes. The five benzodiazepines were directly spiked into the supematant of the biological samples over a range of 0.50-10 μg/mL. The ADS-SPME fiber was submerged into 1.5 mL of the urine, contained in a 2.0 mL amber sample vial. Magnetic stirring with a 0.60 cm long Teflon-coated stir bar was used to agitate the sample at 800 RPM for direct extraction over 60 minutes. The ADS-SPME fiber was rinsed twice by total immersion in water before interfacing to the HPLC system for desorption and separation of the extracted analytes.

### Results and Discussion

A biocompatible solid phase microextraction (SPME) fiber was prepared using an alkyl-diol-silica (ADS) restricted access material as the SPME coating. The ADS material was able to fractionate the protein component from a biological sample, while simultaneously extracting several benzodiazepine compounds. The fiber was directly interfaced with a HPLC-UV system and an isocratic mobile phase was used to desorbe, separate and quantify the extracted compounds. The calculated clonazepam, oxazepam, temazepam, nordazepam and diazepam detection limits were 600, 750, 333, 100, 46 ng/mL in urine, respectively. The method was confirmed to be linear over the range of 500-50000 ng/mL with an average linear coefficient (R²) value of 0.9918. The injection repeatability and intra-assay precision of the method were evaluated over ten injections, resulting in a % R.S.D. <6%. The ADS SPME fiber was robust, providing many direct extractions and subsequent determination of benzodiazepines, while overcoming the present disadvantages of direct sampling of biological matrices by SPME.

### Immobilization of ADS Material

The immobilization of the ADS particles was accomplished by gluing the particles on to a cleaned silica fiber. Several glues were investigated for their physical and chemical stability, however, the Locktite® 349 adhesive provided the most uniform and robust bonding of the ADS particles to the silica fiber. Scanning electron micrographs of blank silica (a) and ADS-SPME (b) fibers were recorded for comparison purposes. As shown in FIG. 3, the confirmation of the ADS particles immoblized on the fiber over a fairly uniform coating was obvious.

The extraction mechanism of the ADS-SPME coating was absorption as the analytes partition into the C18 stationary phase of the inner pores. Extraction of analytes by C18 is a well utilized chemistry as indicated by the common use of C18 analytical columns and solid phase extraction (SPE) cartridges. Although, similar SPME fibers based on this chemistry have been prepared, they did not posses a biocompatible surface to prevent protein adsorption and were therefore restricted to much cleaner matrices like water samples (Y. Liu, M. L. Lee, K. J. Hageman, Y. Yang, and S. B.

Hawthorne, Anal. Chem. 1997, 69, 5001; Y. Liu, Y. Shen, and M. L. Lee, Anal. Chem. 1997, 69, 190).

The C18 extraction process is non-competitive (in comparison to adsorption) and the amount of analyte extracted from a sample is independent of the matrix composition. Once equilibrium is reached, the extracted amount is constant and is independent of further increases in extraction time. For sufficiently large sample volume, in relation to the fiber coating volume (V_{f}), and a constant fiber coating/sample partition constant (K_{fs}) the amount of analyte extracted (n) is directly proportional to the concentration sample (Cₒ), as represented by Equation 1 (J. Pawliszyn, Solid Phase Microextraction—Theory and Practice, Wiley-VCH, New York, 1997, pp. 15-16):

n=K_{fs}V_{f}C₀ (1)

From Equation 1, the calibration curve was therefore expected to be linear and the sensitivity of the extraction was related to the partition coefficient of the analyte in the sample for the fiber coating.

### ADS-SPME Fiber Validation

The extraction performance of the ADS-SPME fiber was validated using ³H-diazepam and liquid scintillation detection. This approach was chosen due to its simplicity, speed and sensitivity. The reproducibility of the coating was tested with 5 independently prepared ADS-SPME fibers. The fibers were submerged in a 3.43 ng/mL standard ³H-diazepam solution (in 95:5 water:methanol) for three hours on a shaking bed. The fiber was then removed from the solution, washed twice by totally immersion in 95:5 water:methanol and placed in a scintillation vial containing 20 mL of scintillation cocktail. The vials were vigorously shaken and counted in triplicate with the liquid scintillation counter for 5 min. The average value of the three counts was considered as the final counting result. In addition, a bare silica fiber (control) was evaluated in the 3.43 ng/mL standard ³H-diazepam solution and an ADS-SPME fiber evaluated in a blank 95:5 water:methanol solution. The complete desorption of the ³H-diazepam from the fibers was confirmed by subsequent counting of the fiber in fresh scintillation cocktail. In order to correlate the DPM counts to a diazepam mass value, a standard ³H-diazepam mass calibration curve was prepared by directly spiking ³H-diazepam into the scintillation cocktail. Table 1 summarizes the scintillation results, corresponding mass of diazepam extracted by each fiber and its reproducibility.

TABLE 1
³H-Diazepam Extraction Performance of ADS-SPME Fibers

| DPM Counts (Mass Extracted) | |
|---|---|
| Blank | 3.43 ng/mL ³H-Diazepam |

| Trial number | ADS fiber | Silica fiber | ADS fiber |
|---|---|---|---|
| 1 | 69 (0) | 127 | 796690 (1.65 ng) |
| 2 | 73 (0) | 134 | 898580 (1.86 ng) |
| 3 | 72 (0) | 123 | 825393 (1.71 ng) |
| 4 | 68 (0) | 128 | 809744 (1.68 ng) |
| 5 | 68 (0) | 130 | 860808 (1.79 ng) |
| % R.S.D. | 3.35 | 3.14 | 4.93 |

As expected, the scintillation values of ADS in the blank solution were equal (within experimental error) to the background value of the scintillation cocktail. Similarly, the amount of diazepam binding to the bare silica control fiber was determined to be negligible. However, the ADS-SPME coating on the fiber's surface was successful in extracting a significant portion of the diazepam from the sample. The diazepam penetrated into the porous structure of the ADS and was absorbed by the C18 extraction phase. The preparation of the ADS-SPME fibers and the extraction procedure was determined to be very reproducible with a % R.S.D value of <5%.

An ADS-SPME extraction time profile for ³H-diazepam was obtained by preparing a set of 3.43-ng/mL ³H-diazempam standard samples (prepared in 95:5 water:methanol) and extracting them for progresses longer periods of time. This profile was useful to confirm the ADS-SPME fiber's ability to extract diazepam and to determine the maximum sensitivity, reached at equilibrium, under the specified experimental conditions. The extraction profile, shown in FIG. 4, indicates an increase in the amount of diazepam extracted with increasing exposure of the ADS-SPME fiber to the standard solution. In FIG. 4, the y-axis shows the ³H-diazepam count, the x-axis shows the time in minutes. This trend eventually reaches a plateau, indicating equilibrium conditions where the total mass of analyte extracted was 1.72 ng.

Equation 1 predicts that the amount of analyte extracted by the ADS-SPME fiber is linearly proportional the sample's concentration. To confirm a linear extraction response, an ADS-SPME fiber was used to extract ³H-diazempam over a concentration range of 0.03-3.43 ng/mL (n=6). The calibration curve demonstrated excellent linearity, with a R² value of 0.9988.

Further enhancements in the sensitivity ADS-SPME approach are possible through optimization of the sample matrix. For example, the effects of experimental parameters such as sample salt concentration and pH on the SPME extraction efficiency has been previously discussed (Pawliszyn, J. (ed.) Applications of Solid Phase Microextraction. RSC, Cornwall, UK, 1999). However, the results obtained in this study, based on experiments using salt concentrations over the range of 0.01-5 mg/mL NaCl, did not show any significant difference in extraction efficiency for diazepam. The pH of the sample can effect the net charge of an analyte and will therefore also influence the extraction efficiency of the ADS-SPME fiber. The C18 extraction phase of the ADS coating was neutral and optimal extraction will occur with neutral compounds. From the structural and pKa information of the evaluated benzodiazepines, the compounds were determined to be neutral at physiological pH. Previous SPME studies using neutral coatings for the extraction of benzodiazepines have confirmed optimal extraction conditions near a physiology pH (H. Yuan, Z. Mester, H. Lord and J. Pawliszyn, J. Anal. Toxicol. 2000, 24, 718; K. Jinno, M. Taniguchi, and M. Hayashida, J. Pharm. Biomed. Anal. 1998, 17, 1081). Therefore, the pH of the sample was not further investigated and no salt adjustment was performed since the purpose of this work was to minimize the sample preparation requirements.

### ADS-SPME HPLC Interfacing

The simple extraction of ³H-diazepam by the ADS-SPME fiber was confirmed to be reproducible, sensitive and linear over a wide dynamic range (2 orders of magnitude). However, the interfacing of the ADS-SPME fiber to HPLC was essential for convenient desorption and separation of the extracted benzodiazepines. A modified SPME-HPLC interface was constructed to accommodate larger diameter fibers and is shown in FIG. 2. Some important considerations must be followed when designing such an interface. The void volume introduced by the interface must be minimized to restrict band broadening of the desorbed analytes. Also, the linear flow velocity through the interface should be as high as possible. Therefore, the thru-hole in the tee should be matched as closely as possible to the outside diameter of the ADS-SPME fiber. The ADS-SPME fiber interface must also withstand the high pressures of HPLC. A short length of 1/16″ o.d. PEEK tubing was used as sheath for the ADS-SPME fiber and positioned in a one piece finger tight PEEK fitting for sealing of the fiber in the interface. The inner diameter of the PEEK tubing was also closely matched to the outer diameter of the ADS-SPME fiber, providing a seal that could withstand pressures close to 2000 psi.

### Desorption and Separation of Extracted Benzodiazepines

In its most convenient form, the ADS-SPME HPLC experimental set-up required a mobile phase composition that provides complete desorption of the extracted analytes from the ADS fiber, but still provides the necessary chromatographic separation of the compounds on the analytical column. Since the ADS-SPME coating possessed the same stationary phase chemistry (C18 reverse phase) as the analytical column, an understanding of the required desorption conditions was available from the distribution constants experimentally determined by direct injection of the benzodiazepines standards on the analytical column. Mobile phase conditions that produced long retention times for the benzodiazepines standards on the analytical column (and hence high distribution constant) would result in poor elution of the analytes from the ADS fiber. In contrast, short retention times (low distribution constants) will ensure rapid desorption from the fiber. The polarity of the mobile phase could be adjusted to ensure the rapid desorption of the compounds from the ADS fiber, while still allowing their separation on the analytical column. The mobile phase optimization procedure was performed by injecting a 10-μL aliquot of a benzodiazepine standard mixture into the HPLC system while using various ratios of water:methanol (v/v) for the mobile phase. The recorded chromatograms are shown in FIG. 5 (x-axis=time (minutes), y-axis=absorbance). As expected, decreasing the polarity of the mobile phase with a higher percentage of methanol produced shorter elution times for the benzodiazepines but also sacrificed the chromatographic resolution. However, the mobile phase conditions in FIG. 5 (c) provided good separation of the compounds (resolution=1.5) while maintaining a reasonable elution time. This mobile phase composition represented the lowest possible polarity, important for desorption of the extracted compounds from the ADS fiber, while still providing adequate chromatographic resolution by the analytical column and was used in all subsequent ADS-SPME HPLC analysis.

### Urine Analysis

The heterogeneity of biological samples complicates benzodiazepine analysis as the direct injection of the sample into a chromatographic system is prohibited by the presence of many contaminates and interferents. Therefore, sample preparation and cleanup approaches such as liquid-liquid extraction or solid phase extraction (SPE) have been developed. Although, the undesirable solvent requirements of these approaches has been eliminated with SPME (K. J. Reubsaet, H. R. Norli, P. Hemmersbach, and K. E. Rasmussen, J. Pharm. Biomed. Anal. 1998, 18, 667), the biocompatibility of the commercially available SPME fibers is poor. In contrast, the ADS-SPME fiber was able to directly fractionate the protein component from the hydrophobic analytes in the sample without requiring solvents or complicated instrumentation. In comparison to the commercially use of ADS columns, the ADS-SPME fiber also simplified the required experimental apparatus. For example, column switching between the ADS and analytical columns requires a dual pump and valve system. However the ADS-SPME fibers are easily adapted to a standard single HPLC instrument. Therefore, a greater reduction in solvent use fiber is realized with the ADS-SPME fibers.

A simple and isocratic ADS-SPME HPLC method was developed for the extraction and analysis of benzodiazepines in urine samples. The urine samples were spiked over a range of concentrations (0.05-50 μg/mL) with the five benzodiazepine compounds. FIG. 6(a), (b) and (c) represent typical chromatograms for a bare silica control fiber (in 1.0 μg/mL) and the ADS-SPME fiber in a blank and 1.0 μg/mL benzodiazepine spiked urine sample, respectively. As expected, FIG. 6(a) confirms the bare silica rod was unable to extract any detectable amount of the benzodiazepines from the urine sample. An absence of peaks was also observed in the ADS-SPME blank sample chromatogram as shown in FIG. 6(b). This confirms the removal of interfering compounds from the urine sample and illustrates the ability of the ADS-SPME coating to provide a clean extract from this complicated matrix. Since the blank analysis was performed after extracting a 1.0 μg/mL spiked urine sample, the absence of analyte carryover resulting from the previous sample, was also validated. Allowing the ADS fiber to remain in the SPME-HPLC interface over the duration of the chromatographic run can minimize the presence of sample carry over. To test this hypothesis, the ADS-SPME fiber was reinserted in the interface after a benzodiazepine analysis and no detectable compounds were observed. Furthermore, throughout the analysis, blanks were run periodically to ensure the absence of contaminants from sample carry over.

FIG. 6(c) represents the successful extraction of the benzodiazepines (A=Clonazepam, B=Oxazepam, C=Temazepam, D=Nordazepam, E=Diazepam) by the ADS-SPME fiber from urine, followed by the HPLC elution and separation of all compounds. Although the separation of the benzodiazepines was more than adequate for quantification purposes, when compared to the separation of benzodiazepine standards (prepared in water) on the C18 analytical column, some peak tailing was observed. The effect appeared to be more pronounced for the later elution compounds. Compounds with long elution times indicated a high partition coefficient with the C18 stationary phase. Therefore, the elution efficacy of the mobile phase may not have been strong enough for rapid desorption of these compounds from the ADS fiber. It is important to ensure that the extracted compounds are desorped in a narrow band as possible to prevent peak broadening. Increasing the desorption efficacy of the mobile phase, by decreasing its polarity, was not an appropriate solution as the HPLC separation of the separation of the desorbed compounds would be sacrificed (see FIG. 5). Alternatively, a small volume of solvent different than the mobile phase, may be introduced through the SPME HPLC interface for improved desorption efficacy. In addition to the changing the desorption solvent experimental parameters such as increasing the interface temperature can be employed to enhance the elution efficiency.

Calibration curves were constructed over a range of 0.5-50 μg/mL for the five compounds. As shown in Table 2, excellent linearity was observed for all benzodiazepines in urine (average R²=0.9918). The detection limit for each compound was determined at a concentration where the signal/noise ratio was equal to 3 and these calculated concentrations have also been included in Table 2.

TABLE 2
Linear Regression Data for Benzodiazepine Urine Calibration
Curves

| | | | | Detection |
|---|---|---|---|---|
| | Regression line^{a} | | | limit |
| Compound | Slope | Intercept | R² value | (ng/mL) |
| Clonazepam | 7333 | 884 | 0.9955 | 600 |
| Oxazepam | 11950 | 9626 | 0.9806 | 750 |
| Temazepam | 36554 | 11777 | 0.9875 | 333 |
| Nordazepam | 94259 | 30925 | 0.9969 | 100 |
| Diazepam | 389077 | 36060 | 0.9987 | 46 |

^{a}Concentration range = 0.05-50 μg/mL; number of data points = 6.

The detection sensitivity is determined by the magnitude of the coating/sample partition constant (K_{fs}). Since the extraction phase of the ADS fiber's coating was the same stationary phase material of the analytical column, the retention times of the benzodiazepines can be used to estimate to detection sensitivities. Therefore, analytes with long retention times and hence higher K_{fs} values such as diazepam, will have improved detection sensitivities.

The reproducibility of the developed method was determined with ten injections of a 1.0 μg/mL sample. The injection repeatability was calculated as a % R.S.D. for each benzodiazepine HPLC peak area in urine and the average value for all compounds was determined to be 5.2%. The intra-assay precision was determined with repeated analysis of a sample that has been independently prepared, over one day, yielding an average % R.S.D. of 5.9%. The ADS-SPME coating was based on a very robust material. Its stability was evaluated for over 50 analysis with minimal loss of performance.

1. Stationary phase for SPME comprising a surface built up by a restricted access material.

2. Stationary phase for SPME according to claim 1, characterized in that the stationary phase is a hollow fiber whose internal surface is covered with a restricted access material.

3. Stationary phase for SPME according to claim 1, characterized in that the stationary phase is a solid fiber which is covered with a restricted access material.

4. Stationary phase for SPME according to claim 1 one or more of claim 1 to 3, characterized in that the restricted access material comprises a non-swelling inorganic base material.

5. Stationary phase according to claim 1 claim one or more of claims 1 to 4, characterized in that the restricted access material is an ADS (alkyl-diol-silica) material.

6. Stationary phase according to claim 1 one or more of claims 1 to 5, characterized in that the restricted access material consists of particles of a diameter between 5 and 50 μm.

7. Stationary phase according to claim 1 one or more of claims 1 to 6, characterized in that the restricted access material is glued on a support.

8. Device for SPME (Solid Phase Microextraction) comprising a stationary phase according to claim 1 one or more of claims 1 to 7.

9. Method for SPME comprising immersing a stationary phase according to claim 1 one or more of claims 1 to 7 in the sample.

10. Method for SPME according to claim 9 characterized in that the sample is a biological fluid.
